(19) United States
(12) Patent Application Publication
(10) Pub. No.: US 2018/0129826 A1
(43) Pub. Date: May 10, 2018

(54) TECHNIQUES FOR LEVERAGING MULTIPLE CRYPTOGRAPHIC ALGORITHMS FOR AUTHENTICATING DATA

(71) Applicant: QUALCOMM Incorporated, San Diego, CA (US)

(72) Inventors: Justin Yongjin KIM, San Diego, CA (US); Lu XIAO, San Diego, CA (US); Shenghu LIU, San Diego, CA (US)

(21) Appl. No.: 15/344,397

(22) Filed: Nov. 4, 2016

(51) Int. Cl. G06F 21/64; H04L 9/32; H04L 9/06

(52) U.S. Cl. CPC G06F 21/64; H04L 9/3242; H04L 2209/12; H04L 9/0643; H04L 9/0637

(57) ABSTRACT

Techniques for authenticating data on a computing device are provided. An example method according to these techniques includes generating a first cryptographic output by applying a first cryptographic algorithm to each block of a first subset of the plurality of blocks of data to be authenticated, combining a last block of the first cryptographic output with a second subset of the plurality of blocks of data to generate an intermediate result, and generating an authentication output by applying a second cryptographic algorithm to the intermediate result, the second cryptographic algorithm being different than the first cryptographic algorithm.

### BACKGROUND

Cryptographic algorithms can be used to generate an authentication tag that can be used to determine whether data has been modified. A first authentication tag can be generated on the data a first point in time at which the data is known not to have been modified. The first authentication tag can be stored with the data. At a later time, the integrity of the data can be authenticated by generating a second authentication tag on the data as it is at that point in time. The second authentication tag is generated using the same technique as the first authentication tag. The first and second authentication tags should match if the data has not been modified.

### SUMMARY

An example method for authenticating data on a computing device according to the disclosure includes generating a first cryptographic output by applying a first cryptographic algorithm to each block of a first subset of the plurality of blocks of data to be authenticated, combining a last block of the first cryptographic output with a second subset of the plurality of blocks of data to generate an intermediate result, and generating an authentication output by applying a second cryptographic algorithm to the intermediate result, the second cryptographic algorithm being different than the first cryptographic algorithm.

Implementations of such a method can include one or more of the following features. The first cryptographic algorithm is an encryption algorithm and the second cryptographic algorithm is a message authentication code algorithm. The first cryptographic algorithm is a block cipher operating in a first mode of operation, and the second cryptographic algorithm is a Cipher-based Message Authentication Code (CMAC) algorithm. The first mode of operation is a Cipher Block Chaining (CBC) mode of operation. Setting an initialization vector for the first cryptographic algorithm to zero for a first block of the first subset of the plurality of blocks. Generating the first cryptographic output by applying the first cryptographic algorithm to each block of the first subset of the plurality of blocks includes executing a CBC encrypt function on each block of the first subset of the plurality of blocks. Generating the authentication output by applying the second cryptographic algorithm to the intermediate result includes executing the CMAC algorithm on the intermediate result to generate a message authentication code based on the intermediate result. Storing the data and the authentication output in a memory of the computing device, accessing the stored data and the authentication output, authenticating the stored data using the authentication output, and performing a responsive action selected based the determination whether the stored data has been modified. Authenticating the generating a second cryptographic output by applying the first cryptographic algorithm to each block of a first subset of a plurality of blocks of the stored data, combining a last block of the second cryptographic output with a second subset of the plurality of blocks of the stored data to generate a second intermediate result, generating a second authentication output by applying the second cryptographic algorithm to the second intermediate result, and comparing the authentication output to the second authentication output to make a determination whether the stored data has been modified.

An example computing device according to the disclosure includes a processor. The processor is configured to generate a first cryptographic output by applying a first cryptographic algorithm to each block of a first subset of a plurality of blocks of data to be authenticated, combine a last block of the first cryptographic output with a second subset of the plurality of blocks of data to generate an intermediate result, and generate an authentication output by applying a second cryptographic algorithm to the intermediate result, the second cryptographic algorithm being different than the first cryptographic algorithm.

Implementations of such a computing device can include one or more of the following features. The first cryptographic algorithm is an encryption algorithm and the second cryptographic algorithm is a message authentication code algorithm. The first cryptographic algorithm is a block cipher operating in a first mode of operation, and wherein the second cryptographic algorithm is a Cipher-based Message Authentication Code (CMAC) algorithm. The first cryptographic algorithm is an Cipher Block Chaining (CBC) algorithm and the second cryptographic algorithm. The processor is further configured to set an initialization vector for the first cryptographic algorithm to zero for a first block of the first subset of the plurality of blocks. The processor being configured to generate the first cryptographic output by applying the first cryptographic algorithm to each block of the first subset of the plurality of blocks is further configured to execute a CBC encrypt function on each block of the first subset of the plurality of blocks. The processor being configured to generate the authentication output by applying the second cryptographic algorithm to the intermediate result is further configured to execute the CMAC algorithm on the intermediate result to generate a message authentication code based on the intermediate result. The processor is further configured to store the data and the authentication output in a memory of the computing device, access the stored data and the authentication output, authenticate the stored data using the authentication output, and perform a responsive action selected based the determination whether the stored data has been modified. The processor being configured to authenticate the stored data is further configured to generate a second cryptographic output by applying the first cryptographic algorithm to each block of a first subset of a plurality of blocks of the stored data, combine a last block of the second cryptographic output with a second subset of the plurality of blocks of the stored data to generate a second intermediate result, generate a second authentication output by applying the second cryptographic algorithm to the second intermediate result, and compare the authentication output to the second authentication output to make a determination whether the stored data has been modified.

An example non-transitory, computer-readable medium according to the disclosure has stored thereon computer-readable instructions for authenticating data on a computing device. The instructions are configured to cause the computing device to generate a first cryptographic output by applying a first cryptographic algorithm to each block of a first subset of the plurality of blocks of data to be authenticated, combine a last block of the first cryptographic output with a second subset of the plurality of blocks of data to generate an intermediate result, and generate an authentication output by applying a second cryptographic algorithm to the intermediate result, the second cryptographic algorithm being different than the first cryptographic algorithm.

Implementations of such a non-transitory, computer-readable medium can include one or more of the following features. The first cryptographic algorithm is an encryption algorithm and the second cryptographic algorithm is a message authentication code algorithm. The first cryptographic algorithm is a block cipher operating in a first mode of operation, and wherein the second cryptographic algorithm is a Cipher-based Message Authentication Code (CMAC) algorithm. The first cryptographic algorithm is a Cipher Block Chaining (CBC) algorithm.

### BRIEF DESCRIPTION OF THE DRAWINGS

FIG. 1 is a functional block diagram of an example computing device illustrating the techniques disclosed herein.

FIG. 2 is a functional block diagram of an example computing device that can be used to implement the computing device illustrated in FIG. 1.

FIG. 3 is a flow diagram of an example process for authenticating data on a computing device according to the techniques disclosed herein.

FIG. 4 is a flow diagram of an example process for authenticating data on a computing device according to the techniques disclosed herein.

FIG. 5 is a flow diagram of an example process for authenticating data on a computing device according to the techniques disclosed herein.

FIG. 6 is a flow diagram of an example process for authenticating data on a computing device according to the techniques disclosed herein.

FIG. 7 is a flow diagram of an example process for authenticating data on a computing device according to the techniques disclosed herein.

FIG. 8 is a flow diagram of an example process for authenticating data on a computing device according to the techniques disclosed herein.

FIG. 9 illustrates a functional block diagram of an implementation of Cipher Block Chaining (CBC) message authentication code (MAC) algorithm that can be used with the techniques disclosed herein.

FIG. 10 illustrates a function block diagram of an implementation of a Cipher-based Message Authentication Code (CMAC) algorithm that can be used with the techniques disclosed herein.

FIG. 11 illustrates a functional block diagram of an implementation of a CBC-MAC algorithm being used to process a first subset of blocks of a message and a CMAC algorithm being used to process the output of the CBC-MAC algorithm and a second subset of blocks of the message according to the techniques disclosed herein.

### DETAILED DESCRIPTION

Techniques disclosed herein for authenticating data. These techniques can be used to generate a cryptographic output that can be used to ensure the integrity of the data being authenticated (this data is also referred to herein as a “message”). The techniques disclosed herein can use more than one cryptographic algorithm to generate the output for authenticating the message. Using different cryptographic algorithms to process different portions of the message can be advantageous.

One situation where utilizing multiple cryptographic algorithms to generate the cryptographic output is advantageous is where an implementation of a first cryptographic algorithm does not provide for efficient memory management, but a second cryptographic algorithm does provide for efficient memory management. For example, the second cryptographic algorithm may provide an application programming interface (API) that provides for efficient allocation and handling of memory in the computing device on which the implementation of the second cryptographic algorithm is to be executed. However, at least one round or stage of processing of the first cryptographic algorithm and the second cryptographic algorithm are functionally identical, which means that given the same input or inputs of a block of one or more bits of data, the cryptographic output of the at least one round of the first cryptographic algorithm and the second cryptographic algorithm would be identical. The second cryptographic algorithm, which is allocates and utilizes memory more efficiently, can be utilized to execute the at least one round that is functionally identical to that of the first cryptographic algorithm instead of utilizing the first cryptographic algorithm to process the message to be authenticated for the at least one round. The output from the at least one round of the second cryptographic algorithm can then be provided to the first cryptographic algorithm to finish generating the cryptographic output using the remaining rounds of the first cryptographic algorithm that are not functionally identical to one or more rounds of the second cryptographic algorithm. The cryptographic output using this technique will be identical to what the cryptographic output would have been had the first cryptographic algorithm been used for all of the rounds of processing, but the memory allocation and utilization will be benefit from the more efficient implementation of the second cryptographic algorithm for processing the rounds that are functionally identical. The first cryptographic algorithm and the second cryptographic algorithm as referred to herein can be a block cipher algorithm operating in different modes of operation or may be different cryptographic algorithms that are based on block ciphers. The first and second cryptographic algorithms are not limited to particular cryptographic algorithms or modes of operation.

Another situation where utilizing multiple cryptographic algorithms to generate the cryptographic output is advantageous is where the length of the overall message to be processed is not known in advance. Some implementations of a cryptographic algorithm require that the entire message be received before cryptographic processing of the message can be being, while other implementations of cryptographic algorithms can be being processing blocks of the message as they are received. For example, an implementation of a first cryptographic algorithm can require that the entire message be received before processing of the message can begin, while a second cryptographic message can begin processing blocks of the message at the blocks of the message are received. If at least one initial round of the first cryptographic algorithm and at least one initial round of the second cryptographic algorithm are functionally identical, which means that given the same input or inputs, the output of the at least one initial round of the first cryptographic algorithm and the second cryptographic algorithm would be identical given the same block of input data. In this situation, the initial one or more rounds of the second cryptographic algorithm can be used to process blocks of a message as they are received, and the cryptographic output of the initial one or more rounds of the second cryptographic algorithm can be processed by the remaining rounds of the first cryptographic algorithm that are not functionally identical to those of the second cryptographic algorithm. The cryptographic output using this technique will be identical to what the cryptographic output would have been had the first cryptographic algorithm been used for all of the rounds of processing, but the processing of the message can be performed as blocks of the message are received rather than having to wait for the message to be received in its entirety. Accordingly, latency that may have been introduced by having to wait for the entire message to be received can be eliminated. Furthermore, this approach may also benefit from the improved memory allocation and utilization of the first example discussed above. The following examples further illustrate these concepts.

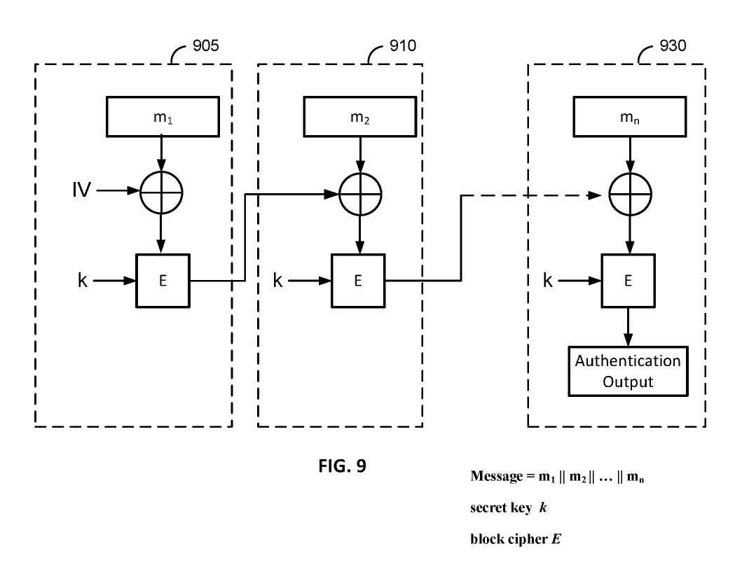

FIG. 9 illustrates a functional block diagram of an implementation of a Cipher Block Chaining (CBC) message authentication code (MAC) algorithm. CBC is one mode of operation of a block cipher algorithm in which a block of plaintext of a message to be processed is exclusively ORed (XORed) with a previous ciphertext block or an initialization vector before being encrypted. The CBC-MAC algorithm uses a block cipher algorithm operating in the CBC mode operation to construct a message authentication code output (also referred to herein as an authentication output). The CBC-MAC algorithm is an example of one block-cipher algorithm that can be used with the techniques disclosed herein. The CBC-MAC algorithm can be used to construct a MAC using a block cipher algorithm. In the example illustrated in FIG. 9, a message m that comprises n blocks of data to be encrypted: m₁∥m₂∥ . . . ∥mₙ. The message is encrypted in series of rounds, with one round for each of the blocks of data of the message. The example illustrated in FIG. 9 illustrates three of these rounds, 905, 910, and 930. At each round an exclusive OR (XOR) operation is performed on a block of message mₓ and the cryptographic output of the previous round, except for the first round in which an initialization vector (IV) can be XOR'ed with the first block of the message m₁. The initialization vector can comprise a randomly selected value that changes each time that the algorithm is executed in order to introduce an additional level of randomization that would make it harder for an attacker to infer information about the secret key based on the plaintext contents of the first block of the message. The block cipher algorithm E is applied to an output of the XOR operation using the secret key k. The particular encryption algorithm applied by the block cipher algorithm can vary from implementation to implementation.

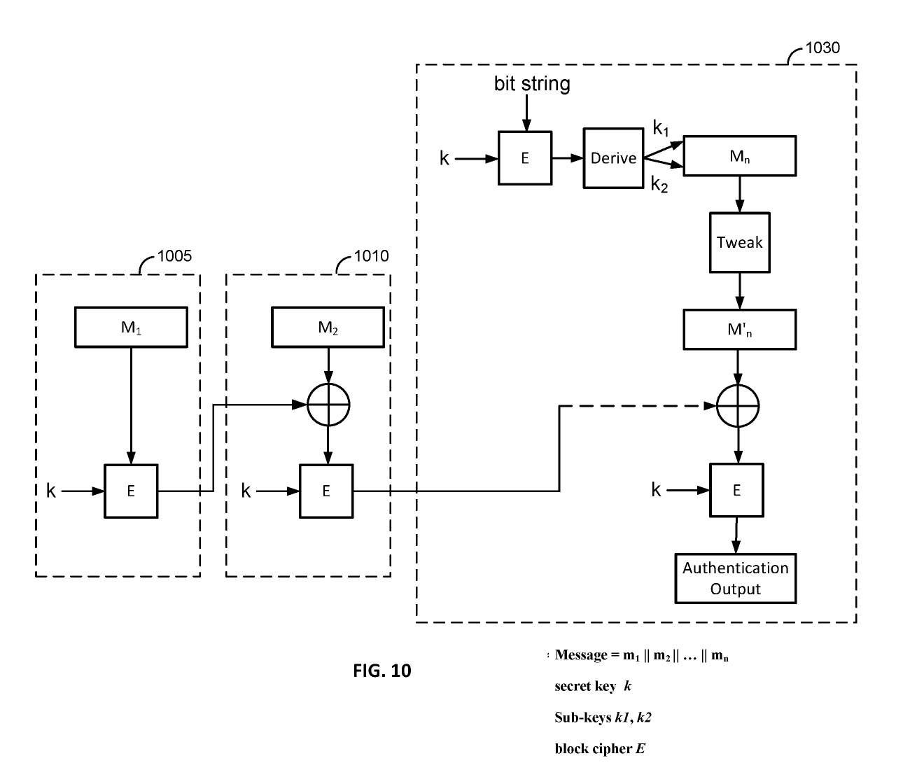

FIG. 10 illustrates a function block diagram of an implementation of a Cipher-based Message Authentication Code (CMAC) algorithm. The CMAC algorithm is an example of one block-cipher algorithm that can be used with the techniques disclosed herein. The CMAC algorithm can be used to generate a message authentication code using a block cipher much like the CBC-MAC algorithm illustrated in FIG. 9, but the final round of the CMAC algorithm (illustrated in round 1030) differs from that of the CBC-MAC algorithm. In the final round of the CMAC algorithm, a key derivation function is used to derive sub-keys k1 and k2 from the secret key k. The key derivation may be performed before or at the final round and the keys may be utilized by the final round. The sub-keys can be used to modify the final block mₙ of the message m to obtain the modified block value of m′ₙ. The first round 1005 differs slightly from that of the first round of the CBC-MAC first round 905 in that the first round 1005 of the CMAC algorithm does not accept an initialization vector. However, round 905 is functionally identical to that of round 1005 if the initialization vector is set to zero. Furthermore, round 1010 of the CMAC algorithm is functionally identical to that of round 910 of the CBC-MAC algorithm.

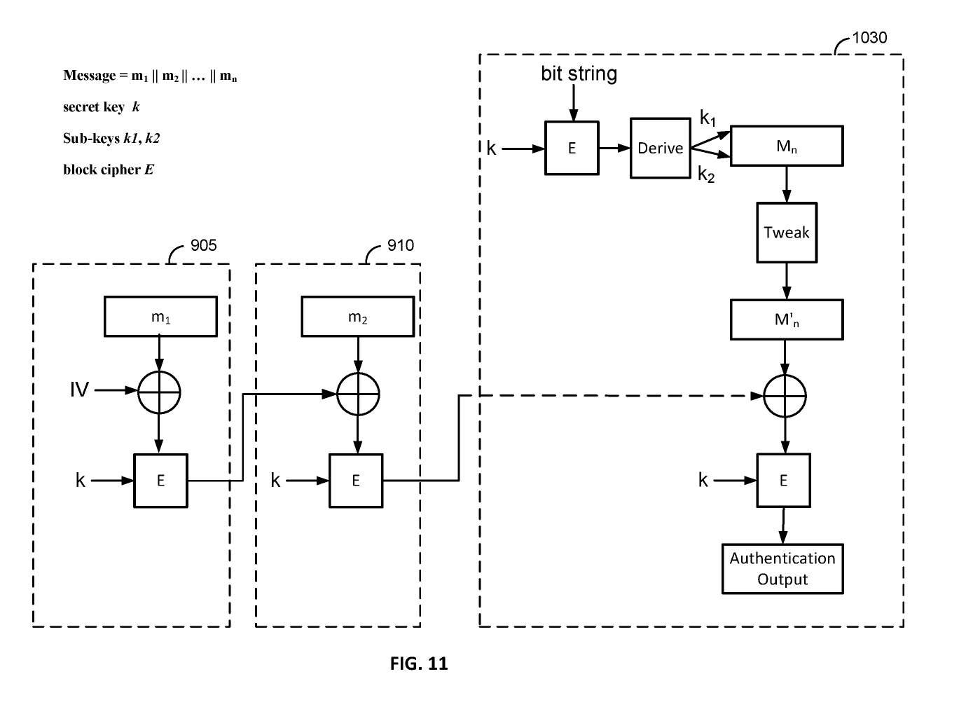

The CBC-MAC algorithm and the CMAC algorithms discussed in the preceding examples can be used to address the situations discussed above where multiple cryptographic algorithms can be used to generate a cryptographic output. The functional similarities between the CBC-MAC algorithm illustrated in FIG. 9 and the CMAC algorithm illustrated in FIG. 10 allow one algorithm to be used to process a first portion of a message and process a second portion of the message to generate a MAC value. FIG. 11 illustrates a functional block diagram of an example implementation of a CBC-MAC algorithm being used to process a first subset of blocks of a message m (rounds 905 and 910). The cryptographic output of the CBC-MAC algorithm can then be combined with the remaining blocks of the message m and the combined value can be processed by the CMAC algorithm (round 1030). The cryptographic output of the CBC-MAC algorithm can then be combined with the remaining blocks of the message m by concatenating the cryptographic output of the CBC-MAC algorithm with the remaining blocks of the message m. The resulting authentication output would be identical to the authentication output produced by the CMAC algorithm operating on the message m as illustrated in FIG. 10. While the example illustrated in FIG. 11 only includes two rounds associated with the first cryptographic algorithm and one round associated with the second cryptographic algorithm, other implementations can include a different number of rounds from one or both of the cryptographic algorithms depending upon the implementations of the two cryptographic algorithms, the length of the message to be authenticated, the number of rounds of the cryptographic algorithms that are functionally identical, and the number of rounds of the cryptographic algorithms are specific to one or the other of the cryptographic algorithms. For example, the functionality of the final round of

An application programming interface (API) provided by a first example implementation of the CMAC algorithm may include three separate function calls that handle the initialization, updating, and finalization functionality associated with generating the ciphertext output. The example implementations is based on the Advanced Encryption Standard (AES) operating in the CMAC mode, but the techniques disclosed herein are not limited to AES. The following example pseudocode illustrates an example of generating the authentication tag (aka, message authentication code) from a 1 gigabyte (GB) message file. The “context” file holds intermediate state information during CMAC operations. The “filePointer” points to a current block of the message file that is to be processed next (if any of the file remains to be processed). The “cipherKey” is the secret key to be used by the CMAC algorithm, and the “bufferToHold1KB” is a buffer that is configured to hold 1 kilobyte (KB) of data.

AES-CMAC-Init(context, cipherKey),

While file-is-not-empty(filePointer)

Begin

Read-File(bufferToHold1KB, filePointer, 1024)

AES-CMAC-Update(context, bufferToHold1KB)

End

AES-CMAC-Final(context, output)

The first example implementation of an API for a CMAC algorithm provides for efficient memory allocation and utilization, and the entire message does not need to have been received before the processing of the message can begin. In contrast, a second example implementation of a CMAC algorithm does not includes separate function calls for initialization, updating, and finalization functionality associated with generating the cryptographic output. Instead, the API provides a single function call for handling all of this functionality:

AES-CMAC(bufferToHoldOneFile, cipherKey, output)

The second example implementation of the API cannot process the message until the entire message is received. Furthermore, the memory usage and allocation are inefficient in the second example implementation. The second implementation would allocate 1 GB of memory to the buffer “bufferToHoldOneFile” in contrast with the much smaller 1 KB file allocated in the first example.

However, if an implementation of the CBC-MAC algorithm is available, the CBC-MAC algorithm can be used to process the first n−1 blocks of the message m, and the cryptographic output of the CBC-MAC algorithm would be identical to that of the output of the CMAC algorithm on the first n−1 blocks of the message m. Each round or stage of the CBC-MAC algorithm is functionally identical to the first n−1 rounds or stages of the CMAC algorithm that would be applied to the first n−1 blocks of data of the message m, as illustrated in FIGS. 9 and 10. The last block of the output from the CBC-MAC algorithm can then be combined with the n^{th} (final) block of the message to generate an intermediate result and the intermediate result can be processed using the CMAC algorithm. The last block of the output from the CBC-MAC algorithm can be concatenated with the n^{th} (final) block of the message to generate the intermediate result. The result of this process would be the same cryptographic output that would have been generated by processing the message m using only the CMAC algorithm, but the inefficient allocation and utilization of memory can be avoided. Plus, the message m can begin to be processed using the CBC-MAC algorithm as the message is being received, rather than having wait for the entire message to be received. In the preceding example, a first cryptographic algorithm is applied to the first n−1 blocks of a message comprising n blocks of data and a second cryptographic algorithm is applied to the nth block of data. However, in other implementations, the second cryptographic algorithm can be applied to a subset of the blocks of the data that include more than just the last block of data as in the preceding example. The number of blocks of the message processed by the first cryptographic algorithm versus the number processed by the second cryptographic algorithm can depend on the cryptographic algorithms that are being applied to the message and other factors.

The examples illustrated in FIGS. 9 and 10 utilize the AES CBC mode to achieve progressive implementation the AES CMAC mode, the techniques disclosed herein are not limited to AES. The techniques illustrated herein can be applied to the CMAC calculation of any block cipher, including but not limited to AES. Some examples of block cipher algorithms that can be used include RC6 (Rivest cipher 6), KASUMI, and 3DES (Triple Data Encryption Algorithm). However, the block cipher algorithm is not limited to these specific block cipher algorithms.

Furthermore, while the example implementations illustrated herein utilize two encryption algorithms to authenticate data, other implementations can use more than two cryptographic algorithms. More than one cryptographic algorithm could be used to process portions of the data to be authenticated by a first cryptographic algorithm so long as the one or more rounds or stages of the more than one cryptographic algorithm used to process portions of the data are functionally identical to the one or more rounds or stages of the first cryptographic algorithm for which the one or more rounds of the more than one cryptographic algorithm are being substituted. The rounds or stages of the first cryptographic algorithm are functionally identical to the rounds or stages of the second cryptographic algorithm, if given the same input or inputs of a block of one or more bits of data, the cryptographic output of the at least one round of the first cryptographic algorithm and the at least one round of the second cryptographic algorithm would be identical.

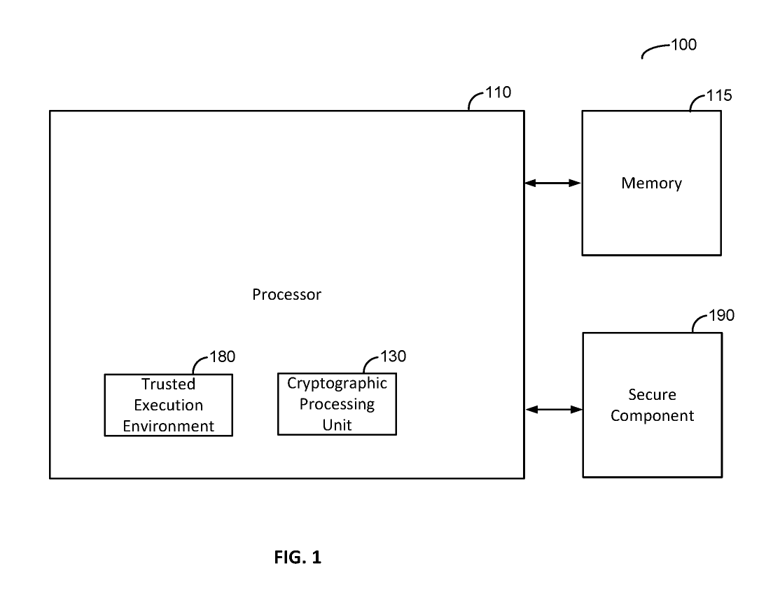

FIG. 1 is a functional block diagram of an example computing device 100 that can be used to perform the techniques for authenticating data disclosed herein. The computing device 100 includes a processor 110. The processor 110 can be communicatively coupled to a computer-readable memory, such as the memory 115, that can be used to store data used by the processor 110. The memory 115 can comprise volatile memory, non-volatile memory, or a combination thereof. The processor 110 can be configured to perform the various processes discussed herein for authenticating data disclosed herein. The processor 110 can be configured to perform the various processes discussed herein for authenticating data disclosed herein. The computing device 100 can comprise a chip component (e.g., an integrated circuit, system on a chip (SOC)) or a downstream product incorporating such a chip component such as a mobile communication device, a User Equipment (UE), a mobile station, a terminal, an access terminal, a subscriber unit, a station, etc. The computing device 100 can also be a smartphone, a tablet computer, a laptop computer, game console, wearable device (such as a smart watch), vehicle-mounted computing device, or other type of computing device. The computing device 100 can be a desktop computer, computer server, or other type of computing device that may be moved but is substantially stationary. The computing device 100 can be configured to include wired and/or wireless network connectivity that enables the computing device 100 communicate with other networked computing devices.

The processor 110 can include a trusted execution environment 180 and/or the computing device 100 can include a secure component 190. The trusted execution environment 180 and the secure component 190 are optional components and one or both of these components may not be included in an implementation of the computing device 100. The trusted execution environment 180 and/or the secure component 190 can be used to implement a secure processing environment for storing sensitive data and for performing processes that need to remain secure, such as performing cryptographic operations on data, storing the cryptographic keys used to perform these operations, storing other sensitive data, or a combination thereof. The trusted execution environment 180 can be implemented as a secure area of the processor 110 that can be used to process and store sensitive data. The trusted execution environment 180 can be configured to execute trusted applications that provide end-to-end security for sensitive data by enforcing confidentiality, integrity, and protection of the sensitive data stored therein. The trusted execution environment 180 can be used to store encryption keys, secure application program code, and/or other sensitive information.

The computing device 100 can include a secure component 190 (also referred to herein as a trusted component) that can be associated with the processor 110. The computing device can include the secure component 190 in addition to or instead of the trusted execution environment 180. The secure component 190 can comprise autonomous and tamper-resistant hardware that can be used to execute secure applications and/or processes. The secure component 190 can be used to implement the processes for mitigating attacks on the baseband process disclosed herein and may implement these processes in combination with the trusted execution environment 180. The secure component 190 can be configured to store sensitive data and to provide confidentiality, integrity, and protection to the data stored therein. The secure component 190 can be used to store encryption keys, user data, and/or other sensitive data. The secure component 190 can be integrated with the hardware of the computing device in a permanent or semi-permanent fashion can be used to securely store data and/or provide a secure execution environment for applications.

The computing device 100 can also include a cryptographic processing unit 130 that is configured to perform the various cryptographic operations and can be used to implement the various techniques disclosed herein. The cryptographic processing unit 130 can be implemented as a trusted application comprising program code executable by the trusted execution environment 180 and/or the secure component 190 and stored in a secure memory location associated with one or both of trusted execution environment 180 and/or the secure component 190 to prevent an attacker from tampering with or disabling the cryptographic processing unit 130. The cryptographic processing unit 130 can also be implemented by a software, hardware, or combination thereof that is implemented outside of a trusted execution environment 180 and/or the secure component 190 (and not every implementation of the computing device 100 necessarily include the trusted execution environment 180 and/or the secure component 190). The cryptographic processing unit 130 can also be implemented in hardware and may be implemented as part of the processor 110 (as shown in FIG. 1) or may be implemented in separate hardware than the processor 110 but may be implemented on the same integrated circuit as the processor 110. The cryptographic processing unit 130 can be implemented as one or more application specific integrated circuits (ASICs), programmable logic devices (PLDs), field programmable gate arrays (FPGAs), or other electronic units designed to perform the functions described herein, or a combination thereof. The cryptographic processing unit 130 can also be implemented as a combination of hardware and software components.

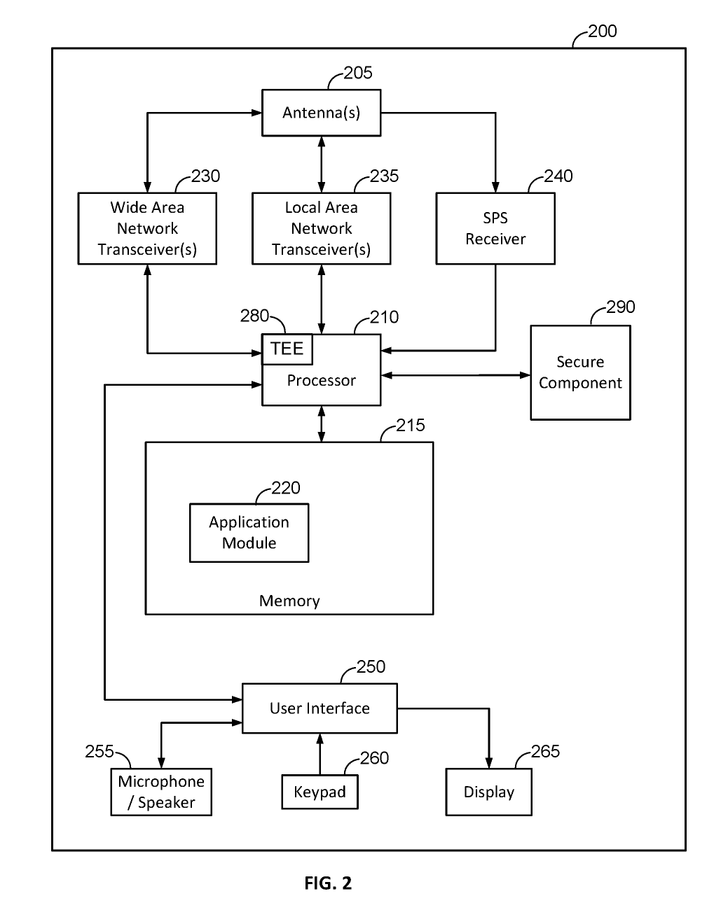

FIG. 2 is a functional block diagram of an example computing device 200 that can be used to implement the computing device 100 illustrated in FIG. 1. FIG. 2 is a schematic diagram illustrating various components of an example computing device 200, which can be similar to or the same as the computing device 100 FIG. 1. For the sake of simplicity, the various features/components/functions illustrated in the schematic boxes of FIG. 2 are connected together using a common bus to represent that these various features/components/functions are operatively coupled together. Other connections, mechanisms, features, functions, or the like, can be provided and adapted as necessary to operatively couple and configure a portable wireless device. Furthermore, one or more of the features or functions illustrated in the example of FIG. 2 can be further subdivided, or two or more of the features or functions illustrated in FIG. 2 can be combined. Additionally, one or more of the features or functions illustrated in FIG. 2 can be excluded.

As shown, the computing device 200 can include one or more local area network transceivers 235 that can be connected to one or more antennas 205. The one or more local area network transceivers 235 comprise suitable devices, circuits, hardware, and/or software for communicating with and/or detecting signals to/from one or more of the WLAN access points, and/or directly with other wireless devices within a network. In some embodiments, the local area network transceiver(s) 235 can comprise a WiFi (802.11x) communication transceiver suitable for communicating with one or more wireless access points; however, in some embodiments, the local area network transceiver(s) 235 can be configured to communicate with other types of local area networks, personal area networks (e.g., Bluetooth® wireless technology networks), etc. Additionally, any other type of wireless networking technologies can be used, for example, Ultra Wide Band, ZigBee, wireless USB, etc.

The computing device 200 can also include, in some implementations, one or more wide area network transceiver(s) 230 that can be connected to the one or more antennas 205. The wide area network transceiver 230 can comprise suitable devices, circuits, hardware, and/or software for communicating with and/or detecting signals from one or more of, for example, the WWAN access points and/or directly with other wireless devices within a network. In some implementations, the wide area network transceiver(s) 330 can comprise a CDMA communication system suitable for communicating with a CDMA network of wireless base stations. In some implementations, the wireless communication system can comprise other types of cellular telephony networks, such as, for example, TDMA, GSM, WCDMA, LTE etc. Additionally, any other type of wireless networking technologies can be used, including, for example, WiMax (802.16), etc.

In some embodiments, an SPS receiver (also referred to as a global navigation satellite system (GNSS) receiver) 240 can also be included with the computing device 200. The SPS receiver 240 can be connected to the one or more antennas 205 for receiving satellite signals. The SPS receiver 240 can comprise any suitable hardware and/or software for receiving and processing SPS signals. The SPS receiver 240 can request information as appropriate from the other systems, and can perform the computations necessary to determine the position of the computing device 200 using, in part, measurements obtained by any suitable SPS procedure. Some implementations of the computing device 200 may not include an SPS receiver.

The processor(s) (also referred to as a controller) 210 can be connected to the local area network transceiver(s) 235, the wide area network transceiver(s) 230, and the SPS receiver. The processor can include one or more microprocessors, microcontrollers, and/or digital signal processors that provide processing functions, as well as other calculation and control functionality. The processor 210 can be coupled to storage media (e.g., memory) 215 for storing data and software instructions for executing programmed functionality within the mobile device. The memory 215 can be on-board the processor 210 (e.g., within the same IC package), and/or the memory can be external memory to the processor and functionally coupled over a data bus.

A number of software modules and data tables can reside in memory 215 and can be utilized by the processor 210 in order to manage both communications with remote devices/nodes, perform positioning determination functionality, and/or perform device control functionality. As illustrated in FIG. 2, in some embodiments, the memory 215 can include an application module 220 which can implement one or more applications. It is to be noted that the functionality of the modules and/or data structures can be combined, separated, and/or be structured in different ways depending upon the implementation of the computing device 200.

The application module 220 can be a process running on the processor 210 of the computing device 200, which can request information from and/or computations be performed by the cryptographic processing unit 130 and/or information or other data from other modules of the computing device 200. Applications typically run within an upper layer of the software architectures and can be implemented in a rich execution environment of the computing device 200.

The processor 210 can include a trusted execution environment 280 and/or the computing device 200 may include a secure component 290. The trusted execution environment 280 and the secure component 290 are optional components and one or both of these components may not be included in an implementation of the computing device 200. The trusted execution environment 280 can be used to implement the trusted execution environment 180 of the processor 110 illustrated in FIG. 1. The trusted execution environment 280 and/or the secure component 290 can be used to implement a secure processing environment for storing sensitive data and for performing processes that need to remain secure, such as the processes disclosed herein for authenticating data.

The trusted execution environment 280 can be implemented as a secure area of the processor 210 that can be used to process and store sensitive data. The trusted execution environment 280 can be configured to execute trusted applications that provide end-to-end security for sensitive data by enforcing confidentiality, integrity, and protection of the sensitive data stored therein. The trusted execution environment 280 can be used to store encryption keys, secure application program code, and/or other sensitive information. The trusted execution environment 280 can be used to implement software and/or hardware components of the cryptographic processing unit 130 illustrated in FIG. 1.

The computing device 200 can include a secure component 290. The mobile wireless device can include the secure component 290 in addition to or instead of the trusted execution environment 280. The secure component 290 can comprise autonomous and tamper-resistant hardware that can be used to execute secure applications and/or processes. The secure component 290 can be used to implement the processes for authenticating data disclosed herein and may implement these processes in combination with the trusted execution environment 280. The secure component 290 can be configured to store sensitive data and to provide confidentiality, integrity, and protection to the data stored therein. The secure component 290 can be used to store encryption keys, user data, and/or other sensitive data. The secure component 290 can be integrated with the hardware of the mobile wireless device in a permanent or semi-permanent fashion can be used to securely store data and/or provide a secure execution environment for applications. The secure component 290 can be used to implement software and/or hardware components of the cryptographic processing unit 130 illustrated in FIG. 1.

The computing device 200 can further include a user interface 250 providing suitable interface systems, such as a microphone/speaker 255, a keypad 260, and a display 265 that allows user interaction with the computing device 200. The microphone/speaker 255 (which can be the same or different from the audio sensor) provides for voice communication services (e.g., using the wide area network transceiver(s) 230 and/or the local area network transceiver(s) 235). The keypad 260 can comprise suitable buttons for user input. The display 265 can include a suitable display, such as, for example, a backlit LCD display, and can further include a touch screen display for additional user input modes.

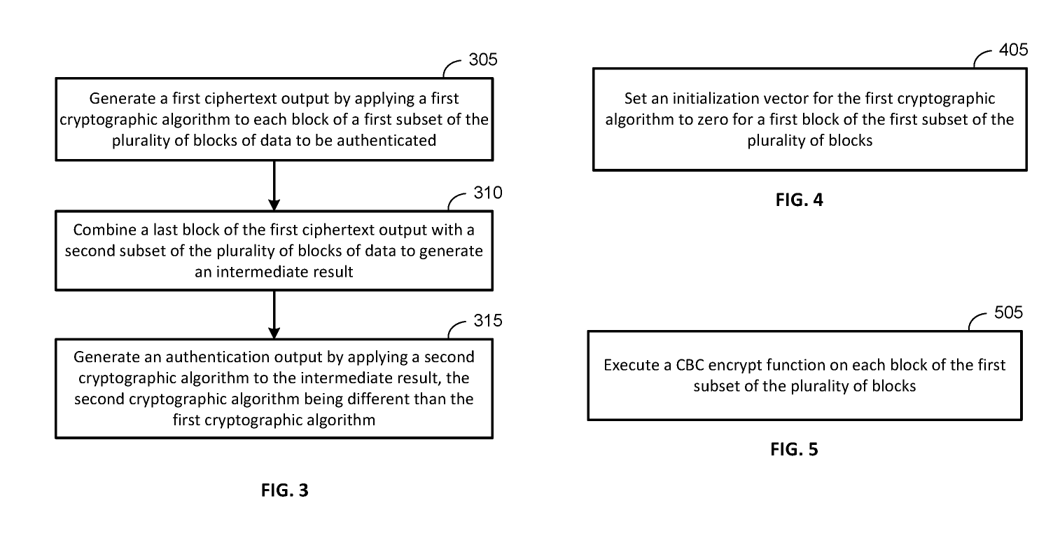

FIG. 3 is a flow diagram of an example process for authenticating data on a computing device according to the techniques disclosed herein. The process illustrated in FIG. 3 can be implemented by the cryptographic processing unit 130 of the processor 110 of the computing device 100. The process illustrated in FIG. 3 can be used to authenticate data that may be used by one or more cryptographic processes on the computing device 100. The process for authenticating data on a computing device can utilize a first cryptographic algorithm and a second cryptographic algorithm that is different than the first cryptographic algorithm. An output from the first cryptographic algorithm can be processed by the second cryptographic algorithm to generate an authentication output that can be used to authenticate the data.

The process illustrated in FIG. 3 can be used to generate an authentication output that can be used to authenticate sensitive data. The cryptographic output may be used to ensure the integrity of the data being authenticated. For example, the trusted execution environment 180 and/or the secure component 190 of the computing device 100 and/or a trusted application being executed by one of these components can generate sensitive data that may be stored in the memory 115 of the computing device 100. The memory 115 can be accessed by applications being executed outside of the trusted execution environment 180 and/or the secure component 190 in the rich execution environment of the computing device 100. The trusted execution environment 180 and/or the secure component 190 may encrypt the sensitive data before storing the data in the memory 115, but encryption does not ensure that the data has not been tampered with while in the memory 115. However, the trusted execution environment 180 and/or the secure component 190 can also generate an authentication value using a cryptographic function that can later be used to determine whether the secure data in the memory 115 has been altered since the authentication value has been generated. Various cryptographic techniques can be used to generate the authentication value, such as a keyed cryptographic hash function, which can be used to generate a message authentication code (MAC) for the sensitive data. The data to be authenticated may, optionally, be encrypted by the trusted execution environment 180 and/or the secure component 190 before writing the sensitive data to the memory 115. The cryptographic algorithm used to generate the MAC or other authentication value can be applied to the sensitive data after the data has been encrypted. The example discussed herein of writing sensitive data to a memory 115 of a computing device 100 is merely utilized to illustrate the concepts disclosed herein and is not intended to limit the usage of these techniques to such an implementation. The process illustrated in FIG. 3 can be used to generate an authentication value for any data for which maintaining the integrity of the data is important.

As discussed in the preceding examples, one or more rounds of the first cryptographic algorithm can be functionally identical to one or more rounds of the second cryptographic algorithm such that the first cryptographic algorithm can be configured to process one or more blocks of the message to be authenticated using the one or more rounds of the first cryptographic algorithm that are identical to the one or more rounds of the second cryptographic algorithm. The output of one or more rounds of the first cryptographic algorithm will be identical to the output of the one or more rounds of the second cryptographic algorithm processing the same one or more blocks of the message.

A first cryptographic output can be generated by applying a first cryptographic algorithm to each block of a first subset of the plurality of blocks of data to be authenticated (stage 305). The data to be authenticated may optionally be first divided into a plurality of blocks prior to stage 305. Each block of data can be of a fixed length and can include one or more bits of data. The block size can depend on the cryptographic algorithms that are to be applied to the data.

The first cryptographic algorithm may be a block cipher algorithm, which is a deterministic algorithm that is configured to operate on fixed-length groups of bits of data. The block cipher algorithm may be of any key length and/or block length. The first cryptographic output can be generated using an iterative process in which one more blocks of the data are processed to generate cryptographic output. Each iteration, also referred to as a “round” herein, can output a block of cryptographic output that is the same size as the block of input data or a block of cryptographic output that is larger or smaller in size as the block of data that served as the input. Some examples of block cipher algorithms that can be used include an Advanced Encryption Standard (AES) (an example of AES Cipher Block Chaining (CBC) message authentication code (MAC) algorithm, referred to herein as “CBC-MAC” is discussed further in an example illustrated in FIG. 9), RC6 (Rivest cipher 6), KASUMI, and 3DES (Triple Data Encryption Algorithm). However, the first cryptographic algorithm is not limited to these specific block cipher algorithms.

The first plurality of blocks of data can include as many as the first n−1 blocks of a message comprising n blocks of data. However, the first cryptographic algorithm can be applied to a subset of the blocks of the data that does not include all but the last block of data of the message. The number of blocks of the message processed by the first cryptographic algorithm versus the number processed by the second cryptographic algorithm can depend on the cryptographic algorithms that are being applied to the message. For example, the number of blocks of the message to be processed can depend on the how many rounds of the first cryptographic algorithm are functionally identical to rounds of the second cryptographic algorithm, where each round of the first cryptographic algorithm and the second cryptographic algorithm are configured to

The last block of the first cryptographic output can be combined with a second subset of the plurality of blocks of data to generate an intermediate result (stage 310). The cryptographic processing unit 130 can be configured to combine the last block of the cryptographic output of the first cryptographic algorithm with the second subset of the plurality of blocks of data of the message in order to generate the intermediate result. The cryptographic processing unit 130 can be configured to combine the first cryptographic algorithm with the second subset of the plurality of blocks of data of the message by concatenating the first cryptographic algorithm with the second subset of the plurality of blocks of data of the message.

An authentication output can be generated by applying a second cryptographic algorithm to the intermediate result, the second cryptographic algorithm being different than the first cryptographic algorithm (stage 315). In the preceding example, the AES CMAC algorithm illustrated in FIG. 10 was used to generate the authentication output, but the techniques disclosed herein are not limited to the this specific algorithm. Other Cipher-based Message Authentication Code (CMAC) algorithms can also be used as the second cryptographic algorithm to generate the authentication output. Other cipher-based cryptographic algorithms can also be used to generate the authentication output. The first and the second cryptographic algorithms can be selected such that one or more rounds of the first cryptographic algorithm are functionally identical to one or more rounds of the second cryptographic algorithm.

FIG. 4 is a flow diagram of an example process for authenticating data on a computing device according to the techniques disclosed herein. The process illustrated in FIG. 4 can be implemented by the cryptographic processing unit 130 of the processor 110 of the computing device 100. The process illustrated in FIG. 4 can be used to implement, at least in part, stage 305 of the process illustrated in FIG. 3.

An initialization vector for a CBC algorithm can be set to zero for the first block of the first subset of blocks of the message used to generate the first cryptographic output (stage 405). The first cryptographic algorithm can be a CBC-MAC algorithm, such as that illustrated in FIG. 9. One of the inputs of the first round of the CBC-MAC algorithm (round 905 in FIG. 9) is an initialization vector (IV). The initialization vector can comprise a randomly selected value that changes each time that the algorithm is executed in order to introduce an additional level of randomization that would make it harder for an attacker to infer information about the secret key based on the plaintext contents of the first block of the message. However, in order to make the first round of the CBC algorithm functionally identical to that of the CMAC algorithm (round 1005 in FIG. 10), the initialization vector should be set to zero, because the first round of the CMAC algorithm is not configured to utilize the IV. But, if the second cryptographic algorithm is an algorithm that is configured to utilize the IV in the first round, then the IV does not need to be zeroed out and can instead be set to a randomized value as in some implementations of the CBC algorithm.

FIG. 5 is a flow diagram of an example process for authenticating data on a computing device according to the techniques disclosed herein. The process illustrated in FIG. 5 can be implemented by the cryptographic processing unit 130 of the processor 110 of the computing device 100. The process illustrated in FIG. 5 can be used to implement, at least in part, stage 305 of the process illustrated in FIG. 3.

A CBC encrypt function can be executed on each block of the first subset of the plurality of blocks (stage 505). The first cryptographic algorithm can be a CBC-MAC algorithm, such as that illustrated in FIG. 9. The CBC-MAC encrypt function can be called on each of the blocks of the first subset of the plurality of blocks to be processed by the CBC-MAC algorithm. As illustrated in FIG. 9, each stage of the CBC-MAC algorithm is configured to apply a block cipher algorithm to the exclusive OR (XOR) of a block of the message and the cryptographic output of the previous round (or the initialization vector if this is the first round).

The cryptographic output from the last block of the first subset of the plurality of blocks can then be combined with the remaining blocks of message that have not yet been processed and can then be processed by the second cryptographic algorithm.

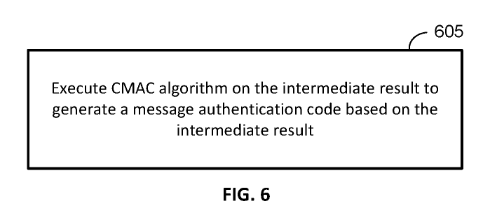

FIG. 6 is a flow diagram of an example process for authenticating data on a computing device according to the techniques disclosed herein. The process illustrated in FIG. 6 can be implemented by the cryptographic processing unit 130 of the processor 110 of the computing device 100. The process illustrated in FIG. 6 can be used to implement, at least in part, stage 315 of the process illustrated in FIG. 3.

A CMAC algorithm can be executed on the intermediate results to generate a message authentication code based on the intermediate result (stage 605). The message authentication code is the authentication output of stage 315 of the process of FIG. 3 where the process of FIG. 6 is used to implement stage 315. The CMAC algorithm can be the AES CMAC algorithm illustrated in FIG. 10 or can be another CMAC algorithm. As discussed above, the intermediate results can be generated by combining the last block of the output of the first cryptographic algorithm with the remaining blocks of the message that were not processed by the first cryptographic algorithm. The last block of the output of the first cryptographic algorithm can be combined with the remaining blocks of the message that were not processed by the first cryptographic algorithm by concatenating the last block of the output of the first cryptographic algorithm with the remaining blocks of the message that were not processed by the first cryptographic algorithm. The CMAC algorithm can be called on this intermediate result. If only one block remains of the message, the final round of the CMAC algorithm can be called (round 1030 in the example implementation of FIG. 10) with the intermediate result as one input and the final block of the data to be authenticated another input. If more than one block remains of the message, then more than one round of the CMAC algorithm will be executed as illustrated in FIG. 10.

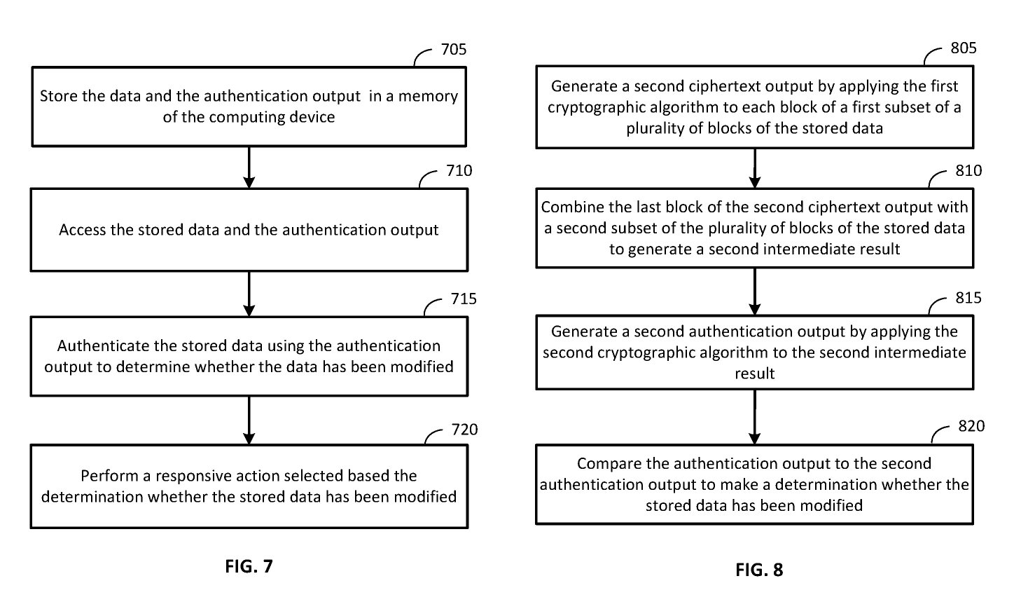

FIG. 7 is a flow diagram of an example process for authenticating data on a computing device according to the techniques disclosed herein. The process illustrated in FIG. 7 can be implemented by the cryptographic processing unit 130 of the processor 110 of the computing device 100. The process illustrated in FIG. 7 can be used to implement, at least in part, additional stages of the process illustrated in FIG. 3.

The data and the authentication output can be stored in a memory of the computing device (stage 705). The data (also referred to herein as the message) and the authentication output that comprises the MAC of the data can be written to the memory 115 of the computing device 100 or another storage location. The data may be stored the memory 115 for later processing by the computing device 100. The authentication output can be generated in stage 315 of the process illustrated in FIG. 3 using the various techniques disclosed herein.

The stored data and the authentication output can be accessed (stage 710). The data and the associated authentication output comprising the MAC of the stored data can be accessed from the memory 115 or other memory location where the data was stored. The authentication output can be used to determine whether the data has been modified since the authentication output was generated in stage 315 of the process of FIG. 3.

The stored data can be authenticated using the authentication output to determine whether the stored data has been modified (stage 715). The stored authentication tag (the authentication output from stage 315 of the process of FIG. 3 that was stored in the memory 115 with the stored data) can be compared to a regenerated authentication tag that is generated using the stored data and the process illustrated in FIG. 3 or whatever process was used to generate the authentication tag. If the authentication tag retrieved from storage, which was generated before or as the data was stored in the memory 115, does not match the regenerated authentication tag, then the data that was stored in memory has been corrupted or tampered with after the stored authentication tag was generated.

One or more responsive actions can be selected to be performed based on the determination whether the stored data has been modified (stage 720). If the data has been modified as determined by stage 715, then one or more responsive actions can be taken. For example, the data may be deleted and/or a process or application that is utilizing the data may be notified and/or halted. Appropriate action may be taken based on how the data was to be used and by which applications or processes.

FIG. 8 is a flow diagram of an example process for authenticating data on a computing device according to the techniques disclosed herein. The process illustrated in FIG. 8 can be implemented by the cryptographic processing unit 130 of the processor 110 of the computing device 100. The process illustrated in FIG. 8 can be used to implement, at least in part, stage 715 of the process illustrated in FIG. 7. The process illustrated in FIG. 8 is similar to the process illustrated in FIG. 3 to originally generate the authentication output that can serve as an authentication tag for the data. If the regenerated tag matches the tag that was stored in the memory with the data and was generated using the process illustrated in FIG. 3, then the tag stored in memory should match the regenerated tag. If the tags do not match, the data has been tampered with or corrupted since the original authentication tag was generated.

Generate a second cryptographic output by applying the first cryptographic algorithm to each block of a first subset of a plurality of blocks of the stored data (stage 805). The second cryptographic output can be generated using a technique similar to that of stage 305 of the process illustrated in FIG. 3. The same first cryptographic algorithm should be applied to the same set of one or more blocks of data of the stored data as was applied in stage 305.

The last block of the second cryptographic output can be combined with a second subset of the plurality of blocks of the stored data to generate a second intermediate result (stage 810). Stage 810 is similar to that of stage 310 of the process illustrated in FIG. 3. The last block of the second cryptographic output can be combined with the with the remaining blocks of the stored data that were not processed by the first cryptographic algorithm to generate a second intermediate result by concatenating the last block of the second cryptographic output can be combined with the with the remaining blocks of the stored data.

A second authentication output can be generated by applying the second cryptographic algorithm to the second intermediate result (stage 815). Stage 815 is similar to that of stage 315 of the process illustrated in FIG. 3. The second intermediate results can be processed by the second cryptographic algorithm applied in stage 315 to generate a second authentication output. The second authentication output represents a regenerated authentication tag for the data that was accessed from memory.

Compare the authentication output to the second authentication output to make a determination whether the stored data has been modified (stage 820). The authentication output, which was generated in stage 315 of the process of FIG. 3 and stored with the data can be compared with the second authentication output generated in stage 815. The two tags should be identical if the stored data has not been modified. If the stored data has been modified or tampered with, the authentication output and the second authentication output will not match.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media. Tangible media include one or more physical articles of machine readable media, such as random access memory, magnetic storage, optical storage media, and so on.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Such media also provide examples of non-transitory media, which can be machine readable, and wherein computers are an example of a machine that can read from such non-transitory media.

The generic principles discussed herein may be applied to other implementations without departing from the spirit or scope of the disclosure or claims.

What is claimed is:

1. A method for authenticating data on a computing device, the method comprising:
generating a first cryptographic output by applying a first cryptographic algorithm to each block of a first subset of the plurality of blocks of data to be authenticated;
combining a last block of the first cryptographic output with a second subset of the plurality of blocks of data to generate an intermediate result; and
generating an authentication output by applying a second cryptographic algorithm to the intermediate result, the second cryptographic algorithm being different than the first cryptographic algorithm.

2. The method of claim 1, wherein the first cryptographic algorithm is an encryption algorithm and the second cryptographic algorithm is a message authentication code algorithm.

3. The method of claim 1, wherein the first cryptographic algorithm is a block cipher operating in a first mode of operation, and wherein the second cryptographic algorithm is a Cipher-based Message Authentication Code (CMAC) algorithm.

4. The method of claim 3, wherein the first mode of operation is a Cipher Block Chaining (CBC) mode of operation.

5. The method of claim 4, further comprising:
setting an initialization vector for the first cryptographic algorithm to zero for a first block of the first subset of the plurality of blocks.

6. The method of claim 3, wherein generating the first cryptographic output by applying the first cryptographic algorithm to each block of the first subset of the plurality of blocks further comprises executing a CBC encrypt function on each block of the first subset of the plurality of blocks.

7. The method of claim 6, wherein generating the authentication output by applying the second cryptographic algorithm to the intermediate result further comprises executing the CMAC algorithm on the intermediate result to generate a message authentication code based on the intermediate result.

8. The method of claim 1, further comprising:
storing the data and the authentication output in a memory of the computing device;
accessing the stored data and the authentication output; and
authenticating the stored data using the authentication output by
generating a second cryptographic output by applying the first cryptographic algorithm to each block of a first subset of a plurality of blocks of the stored data,
combining a last block of the second cryptographic output with a second subset of the plurality of blocks of the stored data to generate a second intermediate result,
generating a second authentication output by applying the second cryptographic algorithm to the second intermediate result, and
comparing the authentication output to the second authentication output to make a determination whether the stored data has been modified; and
performing a responsive action selected based the determination whether the stored data has been modified.

9. A computing device comprising:
a processor configured to:
generate a first cryptographic output by applying a first cryptographic algorithm to each block of a first subset of a plurality of blocks of data to be authenticated;
combine a last block of the first cryptographic output with a second subset of the plurality of blocks of data to generate an intermediate result; and
generate an authentication output by applying a second cryptographic algorithm to the intermediate result, the second cryptographic algorithm being different than the first cryptographic algorithm.

10. The computing device of claim 9, wherein the first cryptographic algorithm is an encryption algorithm and the second cryptographic algorithm is a message authentication code algorithm.

11. The computing device of claim 9, wherein the first cryptographic algorithm is a block cipher operating in a first mode of operation, and wherein the second cryptographic algorithm is a Cipher-based Message Authentication Code (CMAC) algorithm.

12. The computing device of claim 11, wherein the first cryptographic algorithm is an Cipher Block Chaining (CBC) algorithm and the second cryptographic algorithm.

13. The computing device of claim 12, wherein the processor is further configured to set an initialization vector for the first cryptographic algorithm to zero for a first block of the first subset of the plurality of blocks.

14. The computing device of claim 11, wherein the processor being configured to generate the first cryptographic output by applying the first cryptographic algorithm to each block of the first subset of the plurality of blocks is further configured to execute a CBC encrypt function on each block of the first subset of the plurality of blocks.

15. The computing device of claim 14, wherein the processor being configured to generate the authentication output by applying the second cryptographic algorithm to the intermediate result is further configured to execute the CMAC algorithm on the intermediate result to generate a message authentication code based on the intermediate result.

16. The computing device of claim 9, wherein the processor is further configured to:
store the data and the authentication output in a memory of the computing device;
access the stored data and the authentication output; and
authenticate the stored data using the authentication output, the processor being further configured to:
generate a second cryptographic output by applying the first cryptographic algorithm to each block of a first subset of a plurality of blocks of the stored data,
combine a last block of the second cryptographic output with a second subset of the plurality of blocks of the stored data to generate a second intermediate result,
generate a second authentication output by applying the second cryptographic algorithm to the second intermediate result, and
compare the authentication output to the second authentication output to make a determination whether the stored data has been modified; and
perform a responsive action selected based the determination whether the stored data has been modified.

17. A non-transitory, computer-readable medium, having stored thereon computer-readable instructions for authenticating data on a computing device, comprising instructions configured to cause the computing device to:
generate a first cryptographic output by applying a first cryptographic algorithm to each block of a first subset of the plurality of blocks of data to be authenticated;
combine a last block of the first cryptographic output with a second subset of the plurality of blocks of data to generate an intermediate result; and
generate an authentication output by applying a second cryptographic algorithm to the intermediate result, the second cryptographic algorithm being different than the first cryptographic algorithm.

18. The non-transitory, computer-readable medium of claim 17, wherein the first cryptographic algorithm is an encryption algorithm and the second cryptographic algorithm is a message authentication code algorithm.

19. The non-transitory, computer-readable medium of claim 17, wherein the first cryptographic algorithm is a block cipher operating in a first mode of operation, and wherein the second cryptographic algorithm is a Cipher-based Message Authentication Code (CMAC) algorithm.

20. The non-transitory, computer-readable medium of claim 19, wherein the first cryptographic algorithm is a Cipher Block Chaining (CBC) algorithm.
